(19) United States
(12) Patent Application Publication
(10) Pub. No.: US 2022/0219105 A1
(43) Pub. Date: Jul. 14, 2022

(54) NANOFIBER FILTER MATERIAL AND RESPERATORY SYSTEM AND AIR FILTERING ARTICLE

(71) Applicant: L&C Protec, Inc. d/b/a Cocoon, Inc., North Hampton, NH (US)

(72) Inventors: John Peter Lord, Derry, NH (US); Crotty Leo, New Castle, NH (US); Vishal Bansal, Lee's Summit, MO (US); Christopher Ferraro, Leawood, KS (US); Yit-Hong Tee, Lee's Summit, MO (US)

(73) Assignee: L&C Protec, Inc. d/b/a Cocoon, Inc., North Hampton, NH (US)

(21) Appl. No.: 17/379,340

(22) Filed: Jul. 19, 2021

Related U.S. Application Data
(63) Continuation-in-part of application No. 15/435,845, filed on Feb. 17, 2017, now Pat. No. 11,090,589.

(51) Int. Cl. B01D 39/16; B01D 39/08; A62B 23/02

(52) U.S. Cl. CPC B01D 39/1623; B01D 39/083; A62B 23/02; B01D 2239/025; B01D 2239/1258; B01D 2239/1291; B01D 2239/0457; B01D 2239/0627; B01D 2239/0478; B01D 2239/065; B01D 2239/1233

(57) ABSTRACT

A nanofiber based multi-layer filtration material suitable for use in providing air filtration to a user's respiratory system may be provided. as an air filtration garment and/or other air filterina devices such as a face mask, mask and garments or the like. The laminate includes a one or more fabric layer adjacent to one or more nanofiber layers.

### CROSS-REFERENCE TO RELATED PATENT APPLICATION

Tiflis patent application is a. continuation-in-part of U.S. patent application Ser. No. 15/435,845 filed Feb. 17, 2017 and titled “STRETCHABLE LAMINATED FILTER MATERIAL AND PROTECTIVE ARTICLE” which in. turn claims the benefit of U.S. Provisional Patent Application No. 62/297,656, filed Feb. 19, 2016, wherein the entire teachings and disclosure of both applications are incorporated herein by reference.

### FIELD OF THE INVENTION

This invention generally relates to a nanofq)er based multi-layer air filtration material. The nanofiber based, multi-layered filtration material is suitable for use in. providing air filtration to a user's respiratory system and may be provided as an. air filtration garment and/or other air filtering article such as a face mask, mask and garments or the like.

### BACKGROUND OF THE INVENTION

Laminated and non-laminated fabric materials in a respiratory filtration material are known. For example, a filtration fabric may include a membrane capable of filtering fine particulates, such as an expanded polytetrafluoroethylene (ePTFE) membrane, to provide filtration. However, many materials suitable for fine particle filtration lack properties that would be desirable for use in providing air filtration facial masks and/or s garments intended to be worn over the mouth and nose of the user and serve as a respiratory system filter such as a mask, balaclava, scarf, or other similar garment.

In one particular application, military personnel and civilians alike employ durable head gear (e.g., a hood, balaclava, mask or scarf) for head and neck protection while in other applications they may employ a mask type garment for providing air filtration to a user's respiratory system. Typically, such head gear may extend over a user's head, including the mouth and nose area, to provide protection from various physical hazards to the head and/or neck of the user from fire, cold, debris or the like, while generally not providing for air filtration to the user's respiratory system.

For example, U.S. soldiers use protective head gear in desert and cold environments that may be found in Afghanistan, Iraq, etc. Such head gear are typically designed to provide protection from both environmental hazards (e.g., wind, cold, sun) and hostile actions (fire, blast, and other thermal damage). Currentlyavaflable head gear such as hoods or balaclavas used are usually manufactured from common stretchable fabrics potentially with some flame retardant properties. These products do not offer any protection against inhalation of fine sand, aerosolized bacteria, bum pit fumes, smoke, etc. To provide an improved protective hood, improved materials are required in the area of th.e head gear at least covering th.e user's mouth and nose.

The invention provides such an improved multi-layer filter material used alone or in and as port of articles of protective clothing formed therefrom, for use in providing air filtration to a user's respiratory system. By garment the present invention intends to include face masks and any other element, either stretchable or non-stretchable, that is intended to cover at least the nose and mouth of a user to provide air filtration. to the wearer's respiratory system. These and other advantages of the in as well as additional inventive features, will be apparent from the description of the invention provided herein.

### SUMMARY. OF THE INVENTION

In one aspect, the invention provide a stretc-able or non-stretchable multi-layer filter material. The multi-layer filter material includes a nanofiber filtration layer havingfirst. side and a second side, and at least a first fabric layer laminated to the first side of the nanofiber filtration layer.

In one additional feature, the laminate al includes a sec one fabric layer laminated to the second side of the nanofiber filtration lever.

In another feature, the nanofiber filtration layer has a basis weight between about approximately 0.75 to 14.75 grams per m².

In another feature, the nanofiber film is between about 0.0067 microns to about 0.085 microns in thickness.

In another feature, the nanofiber filtration layer includes fibers having a diameter of between. about 100 nm to about 1200 nm. In a further feature, the nanofiber filtrat.ion layer includes fibers having a diameter of between about 350 nm to about 1000 nm. In another feature, the nanofiber filtration layer has particle removal efficiency of at least 75% for particles sized 0.3 micron and greater. In a farther feature, the nanofiber filtration layer has a particle removal efficiency of at least 85% for particles sized 0.3 micron and greater.

In another feature, the nanofiber filtration layer includes a flame retardant, elastomeric polymer. The polymer is selected from the group consisting of thermoplastic polyurethane (TPU) with a flame retardant additive; polyvinylidene difluoride (PVDF); nylon with a flame retardant addjtive; polytetrafluoroethylene (PTFE); and elastomeric block copoymers.

In another feature, the laminate is reversibly stretchable by at least ten percent. In a further feature, the laminate is reversibly stretchable by at least thirty percent.

In another feature, the laminate has a MVTR of at least 15,000 g/m²/day. In a farther feature, the laminate has a MVTR of at least 20,000 g/m²/day.

In another feature, the first fabric layer is selected from the group consisting of woven. fabrics, non-woven fabrics, and knit fabrics. The first fabric layer may include a flame retardant material selected from the group consisting of m-aramid, oxidized polyacrylonitrile (OPAN), liquid crystal thermoplastic polymers, polytetrafluoroethylene (PTFE), flame retardant polyester, and flame-retardant treated cotton.

In another aspect, the invention provides a garment configured to be worn on the head of a user. The garment includes a facial portion configured to cover at least the face of the user. The facial portion comprises a stretchable fabric filter laminate.

In one feature, the garment is a protective hood configured to cover at least 80 percent of the skin of the user's head and neck area when worn. In yet another embodiment, the garment is a balaclava, which is a form of cloth headgear designed to expose only part of the face, usually the eyes, while covering the nose and mouth. In a further embodiment, the garment is a face mask (as in medical face masks) designed to be worn over the nose and mouth of the user.

In yet another aspect, the invention provides a method. The method includes the step of providing a garment with a nanofiber filtration layer. The nanofiber filtration layer has a first side and a second side. The garment also includes a first fabric layer laminated to the first side of the nanofiber filtration layer. The method also includes the steps of positioning the garment on the head of a wearer, and inhaling air through the garment to provide a filtered inhalation air flow to the wearer.

In one feature of the method, the nanofiber filtration layer includes fibers having a diameter of between about 100 nm to 1200 nm. The nanofiber filtration layer also has an air permeability of at least 2092 ft³/min/ft² at 125 Pa, a porosity of at least 80 percent, and an MVTR of at least 15,000 g/m²/day.

It is another aspect of the present invention that person is able to use the garment to filter air during breathing by at least partially covering, ones mouth or nose with the mask or garment.

Another embodime of the present inve ti features a multi-layer fabric configured for forming a multi-layer fabric filter for use in providing air filtration to a user's respiratory system. The multi-layer filter comprises at least one nanofiber filtration layer having a first side and a second side. At least one fabric layer is disposed adjacent to the first side of the nanofiber filtration layer. In another embodiment, a second fabric layer is disposed adjacent the second side of the nanofiber filtration layer.

In a further embodiment, the multi-layer fabric further includes a second nanofiber layer having first and second sides and a third fabric layer having first and second sides, wherein the first side of the second nanofiber layer is disposed proximate the second side of the second fabric layer and the first side of the third fabric layer is disposed proximate the second side of the second nanofiber layer.

The multi-layer fabric may inci de layers that may be laminated to ther in the area of their confronting faces or sides utilizing either adhesive or sonic/heat welding to achieve adhesion. The number of bond spots as well as the size of the bond spots is selected to provide sufficient air permeability to allow the multi ayer fabric to serve as an air filtration layer. Alternatvely the various layers in the multilayer fabric may be adhered or joined only at the perimeter of the layers.

In another alternative embodiment, the various layers may be bonded together using a web bond film which has a number of randomly oriented fine lines or strings of glue which are heat activated and served to bond or laminate to layers together. The web bond sheet is selected so as to provide the desired amount of air permeability to allow the multi aver fabric to be used to provide air filtration to a user's respiratory system by means of a mask or other type of garment.

The present invention features a multi-layer laminate configured for forming a fabric filter for use in providing air filtration to a user's respiratory system. The multi-layer laminate comprises a nanofiber filtration layer having a first side and a second side, wherein the nanofiber filtration layer has a basis weight of between 0.70 to 14.75 grams per m², and wherein the nanofiber filtration layer comprises fibers having a diameter of greater than 350 nm.

The multi-layer laminate includes at least a first fabric layer, wherein the at least a first fabric layer is laminated to the first side of the nanofiber filtration layer and wherein the combination of the at least a first fabric layer laminated to the first side of the nanofiber filtration layer are configured for forming a fabric filter for use in providing air filtration to a user's respiratory system, and wherein the combination of the at least a first fabric layer laminated to the first side of the nanofiber filtration layer provides a particle removal efficiency of at least 75% for particles sized 0.3 microns and greater, an air permeability of at least 20 cfm and a Moisture Vapor Transmission Rating (MVTR) of at least 20,000 g/m²/day.

The multi-layer laminate may further comprise, in another embodiment, a second fabric layer, wherein the second fabric layer is laminated to the second side of the nanofiber filtration layer.

The nanofiber filtration layer of the multi-layer laminate may have a basis weight of between 5 to 50 grams per m² and/or a basis weight between 15 to 30 grams per m². In another embodiment, the nanofiber filtration layer is between 0.0067 mm to 0.085 mm in thickness and/or the nanofibers may have a diameter of between greater than 100 nm to about 1200 nm and preferably between 500 nm to 1000 nm and more preferably between 350 nm and 740 nm.

In another embodiment, the nanofiber filtration layer has a particle removal efficiency of at least 75% for particles sized 0.3 micron and greater.

In a further embodiment, the nanofiber filtration layer may include a flame retardant, elastomeric polymer, wherein the flame retardant, elastomeric polymer is selected from the group consisting of thermoplastic polyurethane (TPU) with a flame retardant additive; polyvinylidene difluoride (PVDF); nylon with a flame retardant additive; polytetrafluoroethylene (PTFE); and elastomeric block copolymers.

In yet another embodiment, the multi-layer laminate may be reversibly stretchable by at least ten percent and preferably by at least thirty percent.

In one embodiment, the first fabric layer is selected from the group consisting of woven fabrics, non-woven fabrics, and knit fabrics.

In another embodiment, the first fabric layer may comprise a flame retardant material selected from the group consisting of m-aramid, oxidized polyacrylonitrile (OPAN), liquid crystal thermoplastic polymers, polytetrafluoroethylene (PTFE), flame retardant polyester, and flame-retardant treated cotton.

In one embodiment, the nanofiber filtration layer is previously fabricated prior to being laminated to at least the first fabric layer. The nanofiber filtration layer may be a centrifugally spun formed nanofiber filtration layer.

In another embodiment, the multi-layer laminate may include a second fabric layer having a first side and a second side, and wherein the second fabric layer is laminated proximate the first side to the second side of the nanofiber filtration layer, and further including a second nanofiber layer having first and second sides and a third fabric layer having first and second sides, wherein the first side of the second nanofiber layer is laminated to the second side of the second fabric layer and wherein the first side of the third fabric layer is laminated to the second side of the second nanofiber layer.

The present invention also includes an article of manufacture configured to be worn on the head of a user, the article of manufacture comprising a multi-layer laminate including at least a facial portion configured to cover the face of the user, wherein the facial portion comprises a fabric and nanofiber filter multi-layer laminate made according to the disclosed invention.

In one embodiment, the article of manufacture is a garment, wherein the garment is a stretchable protective hood configured to cover at least 80 percent of the skin of the user's head and neck area when worn. In a further embodiment, the article of manufacture is a face mask.

The invention also features a multi-layer filter configured for forming a fabric filter for use in providing air filtration to a user's respiratory system. The multi-layer filter comprises a first nanofiber filtration layer having a first planar surface and a second planar surface, wherein the first nanofiber filtration layer has a basis weight of between approximately 0.75 to 14.75 grams per m², wherein the nanofiber filtration layer comprises fibers having a diameter of greater than 350 nm. Also provided are at least a first and a second fabric layers, each of the first and second fabric layers including a first planar surface and a second planar surface. Wherein the first planar surface of the at least a first fabric layer is disposed proximate to the first planar surface of the first nanofiber filtration layer, and wherein the first planar surface of the at least a second fabric layer is disposed proximate to the second planar surface of the first nanofiber filtration layer, and wherein in combination, the first nanofiber filtration layer disposed between the first and second fabric layers are configured for forming a fabric filter for use in providing air filtration to a user's respiratory system, and wherein the combination of the at least a first and a second fabric layer disposed proximate to the first and second side of the nanofiber filtration layer provides a particle removal efficiency of at least 75% for particles sized 0.3 microns and greater, an air permeability of at least 20 cfm and a Moisture Vapor Transmission Rating (MVTR) of at least. 20,000 g/m²/c1

In another embodiment, the multi-layer filter further includes a second nanofiber layer having first and second planar surfaces and a third fabric layer having first and second planar surfaces. The first planar surface of the second nanofiber layer is disposed proximate the planar surface of the second fabric layer and wherein the first planar surface of the third fabric layer is disposed proximate the second planar surface of the second nanofiber layer.

In an additional embodiment, the at least a first and a second fabric layers each include a first planar surface confronting first and second planar surfaces of the first nanofiber layer respectively, and wherein the first and second fabric layers and the first nanofiber layer are laminated together in the area of their confronting surfaces.

In a further embodiment, the at least first and second fabric layers and the first nanofiber layer are laminated together utilizing a method selected from the group consisting of an adhesive, a web bond sheet and sonic/heat welding. In one embodiment, the lamination of the at least first and second fabric layers and the first nanofiber layer occurs along a perimeter of the confronting planar surfaces of the at least first and second fabric layers and the first nanofiber layer while in another embodiment, the lamination of the at least first and second fabric layers and the first nanofiber layer occurs in the confronting planar surfaces utilizing a plurality of bond or lamination points. In this embodiment, a quantity of the plurality of bond or lamination points is selected to provide sufficient air permeability to allow the multi-layer filter to serve as a fabric filter for use in providing air filtration to a user's respiratory system.

In yet another embodiment, the web bond sheet effecting lamination of the at least first and second fabric layers and the first nanofiber layer includes a plurality of randomly oriented lines of heat activatable adhesive serving to laminate the at least first and second fabric layers and the first nanofiber layer together. In this embodiment, the plurality of randomly oriented lines of heat activatable adhesive of the web bond sheet includes a quantity of randomly oriented lines of heat activatable adhesive, which quantity is selected to provide sufficient air permeability to a user's respiratory system allowing the multi-layer filter to serve as a respiratory garment. The respiratory garment may include a face mask configured to be worn over at least the mouth and nose of a user.

Other aspects, objectives and advantages of the invention will become more apparent ftom the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a cross-sectional view of a. multi-laver laminate of the present invention (layer thicknesses not shown to scale);

FIG. 2 is a cross-sectional view of a multi-layer filter material of the present invention wherein is shown only one fabric layer on one side of a nan.ofjber layer (layer thicknesses not shown. to scale);

FIG. 3 is a cross-sectional view of a multi-layer filter material of the present invention illustrating two nanofiber lavers sandwiched between. three fabric lavers layer thicknesses not shown to gcale);

FIG. 4 is a cut-away top-view of a multi-layer filter material of the present invention illustrating various laminating arrangements according to one aspect of the invention;

FIG. 5 is a front view of an embodiment of a protective hood incorporating the multi-layer laminate of the present invention;

FIG. 6 is a perspective view of the protective hood shown in FIG. 5; and

FIG. 7 is a schematic representation of a mask formed by the filter material of the present invention. While the invention will be described in connection with certain preferred embodiments, there is no intent to limit it to those embodiments. On the contrary, the intent is to cover all alternatives, modifications and. equivalents as included. within. the spirit and scope of the invention as defined by the appended claims.

### DETAILED DESCRIPTION OF THE INVENTION

Military personnel currently employ protective hoods in a many situations presenting potentialy-hazardous conditions. Civilians as well as military also have a need and desire to wear respiratory air filtering face coverings, such as face masks, to prevent inhaling unwanted matter such as germs and viruses. To provide suitable protection against fire and thermal injuries, a protective hood known as the Lightweight Protective Hood (LPH) is provided to U.S. military personnel. The LPH is a simple hood or balaclava is formed from a stretchable fabric material with flame retardant properties. However, the LPH does not provide any significant protection from inhalation hazards, for example fine sand and dust, aerosolized bacteria, bum pit fumes, smoke particulates, etc.

To provide such protection from inhalation hazards in a protective hood or in a garment such as a mask, balaclava or the like, a suitable material typically meets some or preferably all of the following:
1. High air permeability (to enable comfortable breathing);
2. High Moisture vapor transmission rate (for user comfort);
3. Good filtration efficiency (to provide inhalation protection);
4. Easy dust release (to prevent plugging of the material with dust);
5. Wash durability up to at least 25 laundry cycles (to be consistent with requirements of individual soldier clothing);
6. Flame retardant (to protect face and neck from burns);
7. Soft, noise-free, and comfortable against the user's skin; and
8. Stretchable (to enable good fit around face).

Many currently-available materials fail to meet at least some of the above properties. For example, ePTFE a commonly used durable filtration material. However, ePTFE membranes fail to provide sufficient air permeability, and are insufficiently stretchable to enable a good fit around the user's face (in the case of a filtration garment or hood). In another example, known laminates including nanofiber films do not release dust, are insufficiently durable when subjected to repeated wash cycles, and are often not flame retardant.

An embodiment of the present invention provides a stretchable, multi-layer filtration laminate suitable for use in protective garments, as described in further detail below. While in another embodiment, the present invention provides a stretchable or non-stretchable laminated or non-laminated multi-layer filtration fabric that is suitable for use in protective garments as well as all types of fabric filters for use in providing air filtration to a user's respiratory system, as also described in further detail below, including a mask, scarf, balaclava all considered a type of garment.

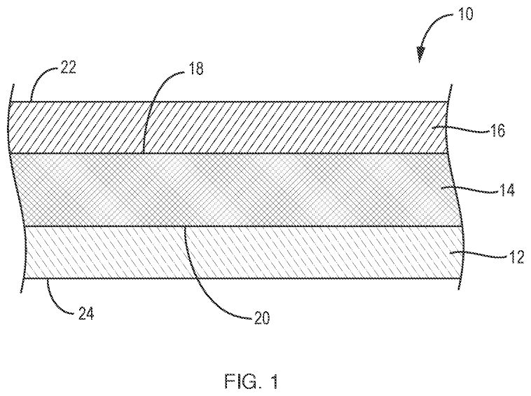

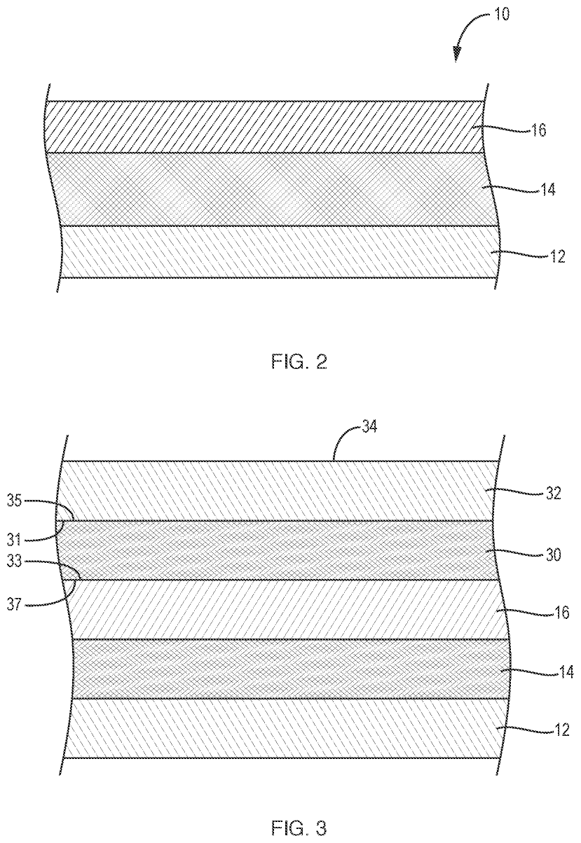

As shown in FIG. 1, a multi-layer air filtering material 10 is provided. The multi-layer material 10 as shown includes at least a first fabric layer 12 and a nanofiber film 14. In preferred embodiments, laminate 10 further includes a second fabric layer 16. However, laminate 10 may be orovided with a sin le fabric layer on only one side of nanofiber layer 14 as shown in FIG. 2 wherein it is shown that fabric layer 12 may be omitted and thus the mui ilayer material incl des only two (2) layers.

Nanofiber film in generally planar and includes a first side 18 and an oio-oosed. second side 20. In a preferred embodiment, nanofiber film 14 is produced by a centrifugal spinning process, such such as disclosed n U.S. Pat. No. 8,647,540, the entire content of which is hereby incorporated by reference in its entirety. Centrifugal spinning is most preferred and has been found to provide a nanofiber film having sufficient coverage, loft, and thickness for proper airflow and permeability suitable for a person to breathe when worn, without creating an overly restrictive film and is suitable for the correct size of diameters various polymeric materials particularly suited for such a garment. Centrifugal spinning does not expand the fibers under the power of a voltage differential, but merely uses centrifugal force to draw fibers down to size.

In other embodiments, a nanofiber film may be produced by an electrospinning process, such as described in U.S. Pat. Pub. Nos. 2009/0127747, 2009/012633, and 2009/0199717, the entire contents of which are hereby incorporated by reference in their entirety. In still other embodiments, a nanofiber film may be produced by an electro-blowing or melt-blowing process. However, in such other embodiments, performance of some properties may be

In a first embodiment, nanofiber film 14 has a thickness of between about 0.0067 mm to 0.085 mm as measured between first side 18 and second side 20. In more preferred. embodiments, the thickness of nanofiber film 14 is between about 0.00672 microns and about 0.085 microns. The thickness of nanofiber film is greater than conventional nanofiber layers typically employed in filtration laminates.

In preferred embodiments, nanofiber film 14 also has a porosity of at least 80 percent. In more preferred embodiments, nanofiber layer 14 has a porosity of at least 85 percent.

In a further embodiment, the multi-layer fabric may include a second nanofiber layer 30, FIG. 3, having first and second sides (planar surfaces) 31, 33, and a third fabric layer 32 having first and second sides (planar surfaces) 34 and 35. In this embodiment, the first side/surface 33 of the second nanofiber layer 30 is disposed proximate and confronting the second side/surface 37 of the second fabric layer 16 while the first side/surface 35 of the third fabric layer 32 is disposed proximate and confronting the second side/surface 31 of the second nanofiber layer 30. Additional nanofiber layers as well as additional fabric layers may be provided as required/desired.

In preferred embodiments, nanofiber film 14 has an. air permeability of at least 2 ft³/min/ft² at 125 Pa, as measured. by ASTM D737. In a more preferred embodiments, nanofiber film 14 has an air permeabili at least 15 ft³/min/ft² at 125 Pa and more preferably approximately 20 ft³/min/ft².

In preferred embodiments, nanofiber film 14 in combination with at least one fabric layer 16 has a filtration efficiency of at least 75% at a particle size of 0.3 micron, as measured by British Standard BS EN1822. In a more preferred embodiment, nanofiber film 14 in combination with at least one fabric layer 16 has a filtration efficiency of at least 85% at a particle size of 0.3 micron. In a still more preferred embodiment, nanofiber film 14 in combination with at least one fabric layer 16 has a filtration efficiency of at least 95% at a particle size of 0.3 micron.

In preferred embodiments, nanofiber film 14 also a Moisture Vapor Transmission Rating (MVTR) of at least 15,000 g/m², as measured by ISO 15496 (inverted cup method). In more preferred embodiments, nanofiber film 14 has a MVTR of at least 20,000 g/m²/day or more. In most preferred. embodiments, nanofiber film 14 has a MVTR of at least 30,000 g/m²/day or more.

Surprisingly, an increased thickness of the nanofiber film 14 relative to nanofiber films present in prior art laminates has been found to improve the resistance of nanofiber film 14 of laminated. material 10 to degradation when subjected to repeated wash cycles typical of a garment, while retaining a high air permeability (at least 15 ft³/min/ft² at 125 Pa, and preferably 20 ft³/min/ft² at 125 Pa), porosity (at least 80 percent, and preferably 85 percent), MVTR (at least 15,000 g/m²/day, and preferably at least 20,000 g/m²/day) , and filtraton efficiency (at least 75% for particles 0.3 micron and larger). In a preferred embodiment of the present invention, nanofiber film 14 retains an air permeability of at least 20 ft³/min/ft² at 125 Pa, a porosity of at least 80 percent, an MVTR of at least 20,000 g/m²/day, and a filtration efficiency of at least 75% for particles 0.3 micron and larger after 25 machine wash cycles in a conventional top-load. washer (approximately 20 minutes agitation, 3 minutes spin drying, and 5 minutes rinse).

As used herein “nanofiber” generally means a fiber having either an average diameter of less than 2 microns and preferably 0.0067 to 0.085 nanometers, and “nanofiber layer” means that the fibers collectively in that layer have a median diameter of less than 2 microns. In typical embodiments, individual nanofibers of nanofiber film 14 have a diameter between about 100 nm nd about 1200 nm. In more preferred embodiments, the individual nanofibers of nanofiber film 14 have a diameter between about 350 nm to about 1000 nm In another embodiment, nanofibers of nanofiber film 14 have a diameter between about 350 nm to about 600 nm. The thickness of the individual nanofibers of nanofiber layer 14 also improves the durability of nanofiber film 14 when sublected to repeated wash cycles, while retaJning high air permeability, porosity, and MVTR, as described above.

In preferred embodiments, nanofiber film 14 is formed from flame retardant, elastomeric polymers. Suitable polymeric materials include thermoplastic polyurethane (TPU) with a flame retardant additive; polyviryl.idene di fluoride (PVDF); nylon. with a flame retardant addJtive; polytetrafluoroethviene (PTFE); and elastomeric block copolymers such as thermoplastic elastomer polyesters (for example, HYTREL® thermoplastic elastomer polyesters, sold by E. I. du Pon.t de Nemours and Co.) and thermoplastic elastomer polyether block amides (for example, PEBAX® polyether block amides, sold by Arkema, Inc.).

In preferred embodiments, nanofiber film 14 has a melting temperature of at least 180 degrees C. In more preferred embodiments, hanofiber film 14 has a melting temperature of at least 200 degrees C.

In some embodiments, an oleophobc treatment is applied to the nanofiber film(s) 14 (30). Oleophobic properties of nanofiber film 14 have been found. to enhance the dust-release properties of the nanofibers. in one preferred embodiment, the oleophobic treatment includes treatment of nanofiber film 14 with a fluorine-containing plasma as disclosed in U.S. Pat. No. 6,419,871, the entire contents of which are hereby incorporated by reference in their entirety.

In other embodiments, a melt--processable oleophnbc compound (e.g., a fluorochemical) may be incorporated into the polymer composition used to form nanofiber film 14. In still other embodiments, an oleophobic compound may be introduced to the nanofiber film 14 after formation by deposition from a solvent carrier and subsecauent removal of the solvent.

Fabric layers 12, 16 (32) may be formed from a woven, non-woven, or knit fabric. Preferred materials are natural or synthetic materials that are flame retardant, non-melting, non-drip materials. Suitable materials include flame retardant polymers like m-aramid, Oxidized Polyacrylonitrile (OPAN), liquid crystal thermoplastic polymers, FIFE, flame retardant polyesters. In other embodiments, natural fibers such as cotton may be used, preferably in combination with a flame-retardant treatment.

At least one fabric layer, shown. as fabric layer 12, is applied to at least one face 18 of nanofiber film 14. In some embodiments, a second fiber layer 16 may be applied to the opposed face 20 of nanofiber layer 14. In one embodiment, nanofiber film 14 and fabric layers 12, 16 are laminated together using a gravure roll printing of a hot-melt adhesive at faces 18, 20 of nanofiber film 14.

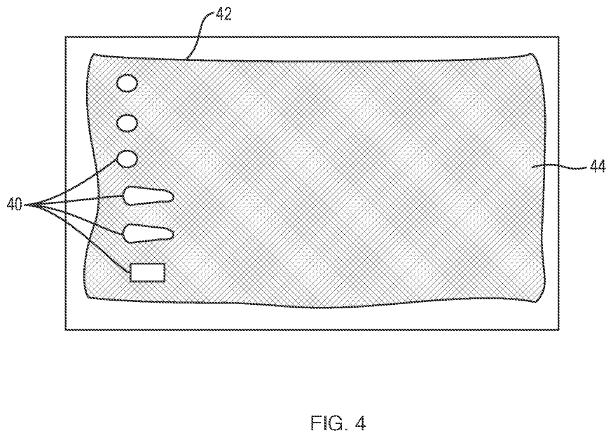

The multi-layer fabric may include layers that may be laminated together in the area of their confronting faces or sides, FIG. 4, utilizing either adhesive or sonic/heat welding to achieve adhesion.

In one embodiment, a number of discrete bond spots 40 are provided. The number and size of bond spots 40 is selected to provide sufficient air permeability to allow the multilayer fabric to serve as an air filtration layer. Alternatively, the various layers in the multilayer fabric may be adhered or joined only at the perimeter 42 of the layers.

In another alternative embodiment, the various layers may be bonded together using a. web bond film 44 which has a number of randomly oriented fine lines or strinas of glue which are heat activated and served to bond or laminate to layers together. The web bond sheet is selected so as to provide the desired amount of air permeability to allow the multilaver fabric to be used to provide air filtration to a user's respiratory system by means of a mask or other type of garment.

In some embodiments, one or both fabric layers 12, 16 may include a hydropthilic treatment to increase w.icking of moisture away from the skin of the wearer. In some embodiments, first fabric layer may include a hydrophilic treatment, while the op)posed second fabric layer may include a hydrophobic treatment to resist absorption of moisture from the environment. In suc h a configuration, garments including the laminate 10 would be configured with. first fabric layer 12 positioned. on the inside of the garment and proximate to the wearer, while the second fabric layer would be positioned on the outside of the garment and distal to the wearer.

Additionally, one or more of layers 12, 14, and 16 may include an anti-static treatment or finish. In some embodiments, one or more layers 12, 14, and 16 may include anti-static carbon fibers or a carbon treatment. In. other embodiments, one or more layers 12, 14, and 16 may include an anti-static chemical treatment.

A desired property of laminate 10 is that the laminate may be reversibly or recoveraby stretched during wear and use. In a preferred embodiment, laminate 10 is reversibly stretchable by at least ten percent as compared to a relaxed dimension (e.g., length or width) of the landnate. In a more preferred embodiment, laminate 10 is reversibly stretchable by at least thirty percent. This stretching occurs without undoing. other properties or features of the fabric and nanofiber layer 14 as described herein.

As used herein, “reversibly stretchable” refers to the ability of a material (i.e., a fabric layer, a nanofiber f-ilm, or a landnated material) to be elastically stretched in a direction in the plane of the material to a length greater than the relaxed (i.e., unstretched) state, without suffering permanent deformation or damage (e.g., plastic deformaton, tearing, or fracture). Thus, the material will naturally return to its unstretched dimensions when the stretching. force is removed, without altering the properties of she material (i.e., air permability, filtration efficiency, MVTR, etc.). In the case of multi-layered. materjals such as laminated material 10, reversible stretching requires that the individual layers of the multi-layer material do not suffer damage or deformation, and further that the multi-layer material also remains intact, that isa with no delamihation, separation, or damage to the bond between individual layers.

The multi-layer laminate described herein preferably has a Moisture Vapor Transmission. Rating (MVTR) of at least 15,000 g/m²/dav, as measured by ISO 15496 (inverted cup method). In more preferred embodiments, the multi-layer laminate has a MVTR of at least 20,000 g/m² day or more. Typically, the MVTR of laminate 10 is limited bv the MVTR of nanofiber film 14.

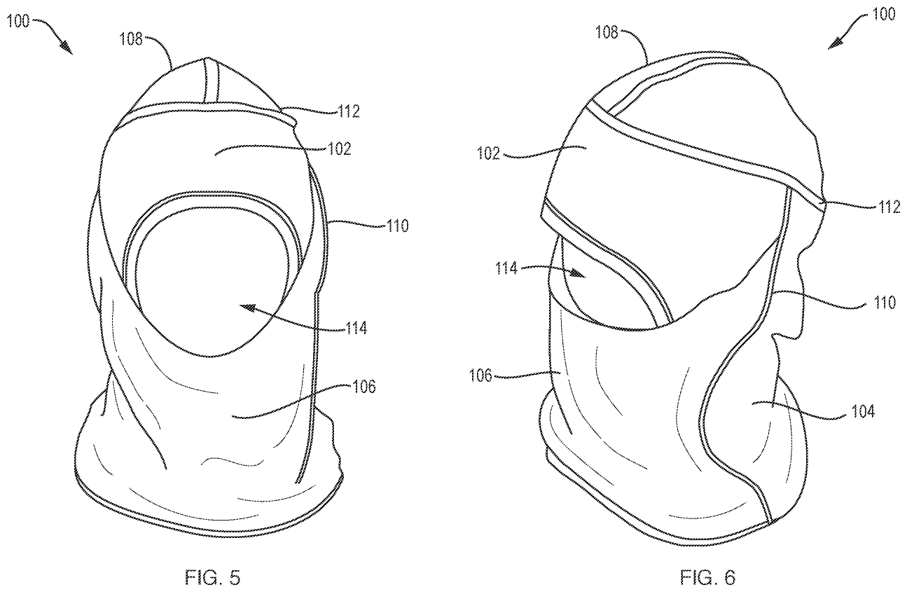

Referring to FIGS. 5 and 6 an exemplary embodiment of a protective hood 100 is shown. Protective hood 100 is configured to be worn on the head of a user. In this embodiment, hood 100 includes front panel 102, rear panel 104, facial panel 106, and cap portion 108. As will be appreciated by those of skill in the art, a protective hood 100 may be assembled in numerous specifc arrangements and conf gurations.

As shown, front panel 102 and rear panel 104 are joined at seam 110. Additionaly, facial panel 106 and rear panel 104 are joined at seam 110. Cap portion 108 is joined to front panel 102 and rear panel 104 at seam 112. In a preferred embodiment, facial panel 106 and rear panel 104 extend downward to further cover the neck of the wearer, thereby minimizing exposed skin of the wearer. The garment is configured to cover at least 80 percent of the skin of user's head and neck area when worn. In typical embodiments, panels 102, 104, 106, and 108 are joined at seams 110 and 112 by sewing. In other embodiments, panels may joined by an adhesive, melting, or any other process, as is generally known in the clothing arts.

Front panel 102 and facial panel 106 partially overlap proximate to seam 110, and define a user-adjustable facial opening 114. Facial covering portion 106 may be selectively adjusted to cover the nose and mouth of the user, the mouth of the user, or neither the nose or mouth out the user, as desired, while leaving the wearer's eyes uncovered. In hazardous enyironments, facial panel. 106 may be worn over the nose and mouth of the user such that inhalation by the user causes inhaled air to be fiftered through facial panel 106 before entering the user's lungs.

In some embodiments, only facial panel 106 is formed from the lamdnate materal 10 of the present invention. Optionally, only a portion of facial panel 106 may be formed from laminate material 10, that is, the area of facial panel 106 proximate to the wearer's mouth and nose. In other embodiments, some or all of front panel 102, rear panel 104, and cap portion 108 may be formed from laminate material 10. In some embodiments, cap portion 108 is formed from a breathable mesh.

In a preferred embodiment, protective hood 100 weighs less than 6 ounces. In a more preferred embodiment, hood 100 weighs between about 2 to 4 ounces.

In various other embodiments, laminated material 10 may be incorporated into numerous other types of protective garments that can provide filtered air to a wearer. For example, a scarf may be provided. In one exemplary embodiment, a scarf is a strip of laminated material between about 3 to 6 feet in length, and naving a width of about four to twelve or more inches. In the event wearer perceives a need for air filtration, the scarf may be wrapped around the wearer's head to cover the mouth and nose of the wearer. In another exemplary embodiment, a shirt may be provide with an extendable turtle neck portion formed from laminated material 10.

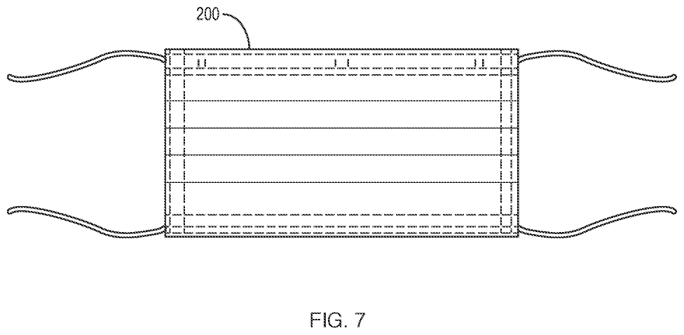

In the event a wearer perceives a need for air filtration, the turtle neck portion may be extended upwards to cover the mouth and nose of the wearer. In another contemplated embodiment, the filter material of the invention is formed/incorporated into a standard face mask 200, FIG. 7 designed and configured to cover the mouth and nose of the user.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover bot:— the singular and the plural, unless otherwise indicated herein or clearly contradicted by context. The terms “comprising,” “having,” “including,” and “containing” are to be construed as open-ended. terms (i.e., meaning. “including, but not limited to,”) unless otherwise noted. Recitation of ranges of values herein are merely intended. to serve as a shorthand. method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided. herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred. embodiments may become apparent to those of ordinary skill in the art upon reading the foregoing description. The inventors expect skilled artisans to employ such variations as appropriate, and the inventors intend for the invention to be practiced otherwise than as specifically described herein.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A multi-layer laminate configured for forming a fabric filter for use in providing air filtration to a user's respiratory system, the multi-layer laminate comprising:
a nanofiber filtration layer having a first side and a second side, wherein the nanofiber filtration layer has a basis weight of between 0.70 to 14.75 grams per m², wherein the nanofiber filtration layer comprises fibers having a diameter of greater than 350 nm; and
at least a first fabric layer, wherein the at least a first fabric layer is laminated to the first side of the nanofiber filtration layer and wherein the combination of the at least a first fabric layer laminated to said first side of the nanofiber filtration layer are configured for forming a fabric filter for use in providing air filtration to a user's respiratory system, and wherein the combination of the at least a first fabric layer laminated to said first side of the nanofiber filtration layer provides a particle removal efficiency of at least 75% for particles sized 0.3 microns and greater, an air permeability of at least 20 cfm and a Moisture Vapor Transmission Rating (MVTR) of at least 20,000 g/m²/day.

2. The multi-layer laminate of claim 1, further comprising a second fabric layer, wherein the second fabric layer is laminated to the second side of the nanofiber filtration layer.

3. The multi-layer laminate of claim 1, wherein the nanofiber filtration layer has a basis weight of between 5 to 50 grams per m².

4. The multi-layer laminate of claim 1, wherein the nanofiber filtration layer has a basis weight between 15 to 30 grams per m².

5. The multi-layer laminate of claim 1, wherein the nanofiber filtration layer is between 0.0067 mm to 0.085 mm in thickness.

6. The multi-layer laminate of claim 1, wherein the nanofiber filtration layer comprises fibers having a diameter of between greater than 100 nm to about 1200 nm.

7. The multi-layer laminate of claim 1, wherein the nanofiber filtration layer comprises fibers having a diameter of between 500 nm to 1000 nm.

8. The multi-layer laminate of claim 1, wherein the nanofiber filtration layer has a particle removal efficiency of at least 75% for particles sized 0.3 micron and greater.

9. The multi-layer laminate of claim 1, wherein the nanofiber filtration layer comprises a flame retardant, elastomeric polymer, wherein the flame retardant, elastomeric polymer is selected from the group consisting of thermoplastic polyurethane (TPU) with a flame retardant additive; polyvinylidene difluoride (PVDF); nylon with a flame retardant additive; polytetrafluoroethylene (PTFE); and elastomeric block copolymers.

10. The multi-layer laminate of claim 1, wherein the laminate is reversibly stretchable by at least ten percent.

11. The multi-layer laminate of claim 1, wherein the laminate is reversibly stretchable by at least thirty percent.

12. The multi-layer laminate of claim 1, wherein the first fabric layer is selected from the group consisting of woven fabrics, non-woven fabrics, and knit fabrics.

13. The multi-layer laminate of claim 1, wherein the first fabric layer comprises a flame retardant material selected from the group consisting of m-aramid, oxidized polyacrylonitrile (OPAN), liquid crystal thermoplastic polymers, polytetrafluoroethylene (PTFE), flame retardant polyester, and flame-retardant treated cotton.

14. The multi-layer laminate of claim 1, wherein the nanofiber filtration layer comprises nanofibers having a diameter of between 350 nm and 740 nm.

15. The multi-layer laminate of claim 1, wherein the nanofiber filtration layer is previously fabricated prior to being laminated to at least said first fabric layer.

16. The multi-layer laminate according to claim 1, wherein the nanofiber filtration layer is a centrifugally spun formed nanofiber filtration layer.

17. The multi-layer laminate of claim 2, wherein said second fabric layer includes a first side and a second side, and wherein the second fabric layer is laminated proximate said first side to the second side of the nanofiber filtration layer, and further including a second nanofiber layer having first and second sides and a third fabric layer having first and second sides, wherein said first side of said second nanofiber layer is laminated to said second side of said second fabric layer and wherein said first side of said third fabric layer is laminated to said second side of said second nanofiber layer.

18. An article of manufacture configured to be worn on the head of a user, the article of manufacture comprising:
a multi-layer laminate including at least a facial portion configured to cover the face of the user, wherein the facial portion comprises a fabric and nanofiber filter multi-layer laminate according to claim 1.

19. The article of manufacture of claim 18, wherein the article of manufacture is a garment, wherein said garment is a stretchable protective hood configured to cover at least 80 percent of the skin of the user's head and neck area when worn.

20. The article of manufacture of claim 18, wherein said article of manufacture is a face mask.

21. A multi-layer filter configured for forming a fabric filter for use in providing air filtration to a user's respiratory system, the multi-layer filter comprising:
a first nanofiber filtration layer having a first planar surface and a second planar surface, wherein the first nanofiber filtration layer has a basis weight of between approximately 0.75 to 14.75 grams per m², wherein the nanofiber filtration layer comprises fibers having a diameter of greater than 350 nm; and
at least a first and a second fabric layers, each of said first and second fabric layers including a first planar surface and a second planar surface, wherein the first planar surface of said at least a first fabric layer is disposed proximate to the first planar surface of the first nanofiber filtration layer and wherein the first planar surface of said at least a second fabric layer is disposed proximate to the second planar surface of the first nanofiber filtration layer, and wherein said multi-layer filter comprising said first nanofiber filtration layer disposed between said first and second fabric layers is configured for forming a fabric filter for use in providing air filtration to a user's respiratory system, and wherein the combination of the at least a first and a second fabric layer disposed proximate to said first and second side of the nanofiber filtration layer provides a particle removal efficiency of at least 75% for particles sized 0.3 microns and greater, an air permeability of at least 20 cfm and a Moisture Vapor Transmission Rating (MVTR) of at. least 20,000 g,/m².

22. The multi-layer filter of claim 21, further including a second nanofiber layer having first and second planar surfaces and a third fabric layer having first and second planar surfaces, wherein said first planar surface of said second nanofiber layer is disposed proximate said second side of said second fabric layer and wherein said first planar surface of said third fabric layer is disposed proximate said second planar surface of said second nanofiber layer.

23. The multi-layer filter of claim 21, wherein said at least a first and a second fabric layers each include a first planar surface confronting first and second planar surfaces of said first nanofiber layer respectively, and wherein the first and second fabric layers and said first nanofiber layer are laminated together in the area of their confronting surfaces.

24. The multi-layer filter of claim 23, wherein said at least first and second fabric layers and said first nanofiber layer are laminated together utilizing a method selected from the group consisting of an adhesive, a web bond sheet and sonic/heat welding.

25. The multi-layer filter of claim 24, wherein said lamination of said at least first and second fabric layers and said first nanofiber layer occurs along a perimeter of the confronting planar surfaces of said at least first and second fabric layers and said first nanofiber layer.

26. The multi-layer filter of claim 24, wherein said lamination of said at least first and second fabric layers and said first nanofiber layer occurs in said confronting planar surfaces utilizing a plurality of bond or lamination points.

27. The multi-layer filter of claim 24, wherein a quantity of said plurality of bond or lamination points is selected to provide sufficient air permeability to allow the multi-layer filter to serve as a fabric filter for use in providing air filtration to a user's respiratory system.

28. The multi-layer filter of claim 24, wherein said web bond sheet effecting lamination of said at least first and second fabric layers and said first nanofiber layer includes a plurality of randomly oriented lines of heat activatable adhesive serving to laminate said at least first and second fabric layers and said first nanofiber layer together.

29. The multi-layer filter of claim 28, wherein said plurality of randomly oriented lines of heat activatable adhesive of said web bond sheet includes a quantity of randomly oriented lines of heat activatable adhesive, which quantity is selected to provide sufficient air permeability to a user's respiratory system allowing said multi-layer filter to serve as a respiratory garment.

30. The multi-layer filter of claim 29, wherein said respiratory garment includes a face mask configured to be worn over at least the mouth and nose of a user.
